(19) United States
(12) Patent Application Publication
(10) Pub. No.: US 2006/0184628 A1
(43) Pub. Date: Aug. 17, 2006

(54) METHOD AND SYSTEM TO COMPOSE AND TRANSMIT DIFFERENT CONTENTS TO DIFFERENT RECEIPIENTS IN A SINGLE MESSAGE

(75) Inventors: Brett A. Coley, Wake Forest, NC (US); Wesley J. Gyure, Raleigh, NC (US); Paul F. McMahan, Apex, NC (US); Robert T. Uthe, Morrisville, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/906,308

(22) Filed: Feb. 14, 2005

(51) Int. Cl. G06F 15/16

(52) U.S. Cl. 709/206

(57) ABSTRACT

A method and system to compose and transmit different contents to different recipients in a single message may include entering a plurality of different contents in a single message. The method may also include assigning at least one recipient of a plurality of recipients to each different contents. The assigning may also provide that each recipient can only view the different contents to which the recipient is assigned. The method may also include securing the different contents such that only the assigned recipient may view said contents.

### BACKGROUND OF INVENTION

The present invention relates to electronic messaging, e-mail and the like, and more particularly to a method and system to transmit different contents to different recipients in a single message.

Electronic messaging (hereinafter “e-mail”, “message”, or “messages”) is a very common form of communication. E-mail allows a user to quickly and easily send messages containing: text, media files, and documents to a recipient throughout the world. Typically, a user composes an e-mail with software running on a communication device. The e-mail includes a delivery address for an intended recipient. The user may send the message to the recipient via a network to which the communication device may have access.

E-mail also allows a user to simultaneously send a message to multiple recipients. The recipients' delivery addresses may be added to the message's “To”, “CC” (carbon copy), and “BCC” (blind carbon copy) fields. When composing a single message to multiple recipients, a user may desire to send a private content to one or a selected portion of the recipients, of the same message.

Currently, a user may not compose a single e-mail for multiple recipients and designate private content to a selected portion of the recipients. With currently known systems, a user must generate separate messages for each private content intended for different recipients. This process may be time consuming, tedious, and frustrating.

### SUMMARY OF INVENTION

In accordance with an embodiment of the present invention, a method to compose and transmit different contents to different recipients in a single message may include entering a plurality of different contents in a single message. The method may also include assigning at least one recipient of a plurality of recipients to each different content. The assigning may also provide that each recipient can only view the different contents to which the recipient is assigned. The method may also include securing the different contents such that only the assigned recipient may view the contents.

In accordance with another embodiment of the present invention, a system to compose and transmit different contents to different recipients in a single message may include a data structure operable on a processor to facilitate entering a plurality of different contents in a single message. The system may also include a data structure operable on the processor to facilitate assigning at least one recipient of a plurality of recipients to each of the different content. The system may also include a data structure operable on the processor to facilitate securing the different contents to permit only the assigned recipient to view the contents.

In accordance with another embodiment of the present invention, a computer program product to compose and transmit different contents to different recipients in a single message may include a computer readable medium having computer readable program code embodied therein. The computer readable medium may include computer readable program code configured to facilitate entering a plurality of different contents in a single message. The computer readable medium may also include a computer readable program code configured to facilitate assigning at least one recipient of a plurality of recipients to each different content. The computer readable program code may further include a computer readable program code configured to secure each private contents to only be viewable by the at least one assigned recipient.

### DESCRIPTION OF THE DRAWINGS

FIGS. 1A and 1B (collectively FIG. 1) are a flow chart of an example of a method to compose and transmit different contents to different recipients in a single message in accordance with an embodiment of the present invention.

FIGS. 2A-2C are an example of a sequence of screen shots, or the like, illustrating creation of a single e-mail including different contents intended for different recipients in accordance with an embodiment of the present invention.

FIG. 3 is a flow chart of an example of a method of receiving a single e-mail including different content intended for different recipients in accordance with an embodiment of the present invention.

FIG. 4 is a block diagram of an exemplary system for composing and transmitting different contents to different recipients in a single message in accordance with an embodiment of the present invention.

### DETAILED DESCRIPTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following detailed description of preferred embodiments refers to the accompanying drawings, which illustrate specific embodiments of the invention. Other embodiments having different structures and operations do not depart from the scope of the present invention.

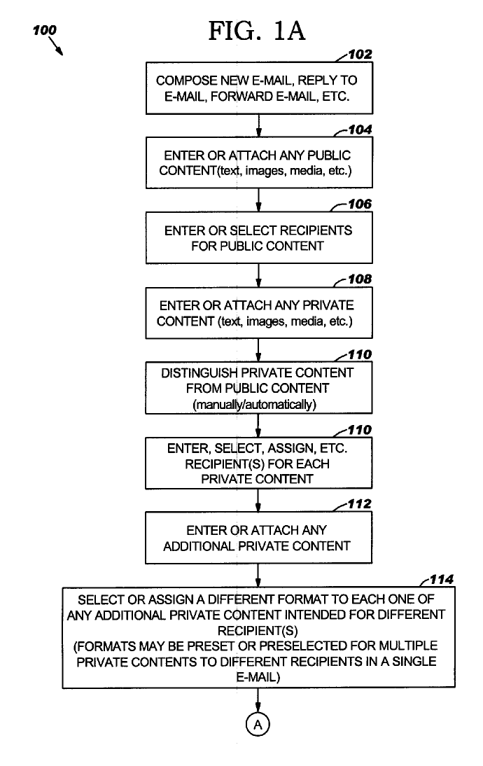

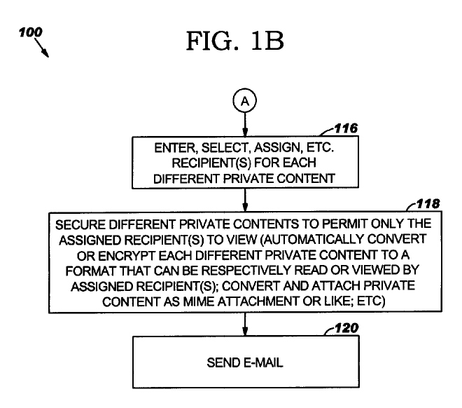

FIGS. 1A and 1B (collectively FIG. 1) are a flow chart of an example of a method 100 for creating a single electronic message (herein after “e-mail” or “message”) in accordance with an embodiment of the present invention. In block 102, a new e-mail, a reply to an e-mail, an e-mail to be forwarded, or the like may be composed or created. Accordingly, the method 100 of the present invention may apply to any form or nature of e-mail. The message may be composed on a communication device, such as a computer system, a personal digital assistant, a cellular phone, or similar devices capable of electronic messaging.

In block 104, the user may enter or attach any public content to the message. All recipients may view any public content. Public content may include: text, media files, hyperlinks, formatted documents, spreadsheets, executable programs, or the like. In block 106, the recipient or recipients of the public content may be entered or selected. A recipient may include an individual, a group, or an entity.

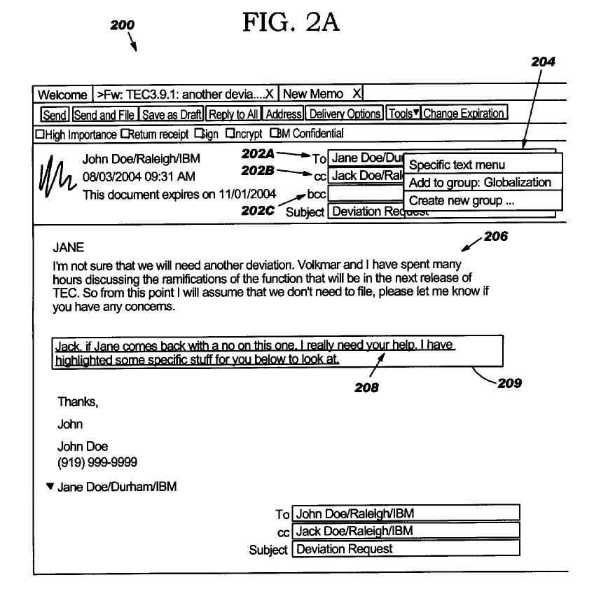

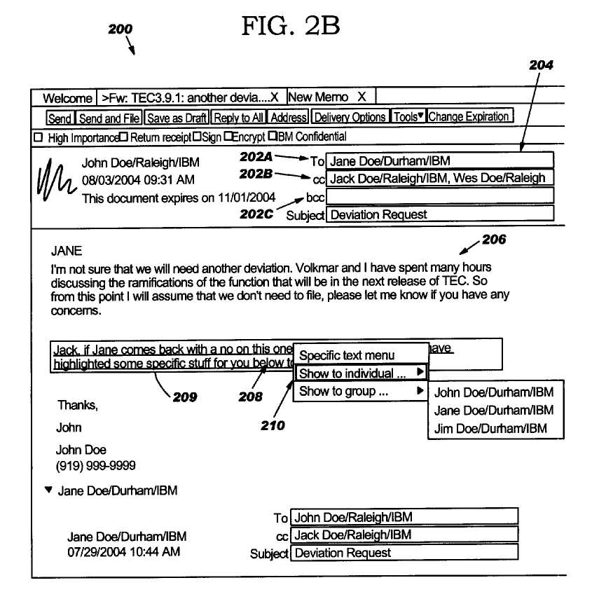

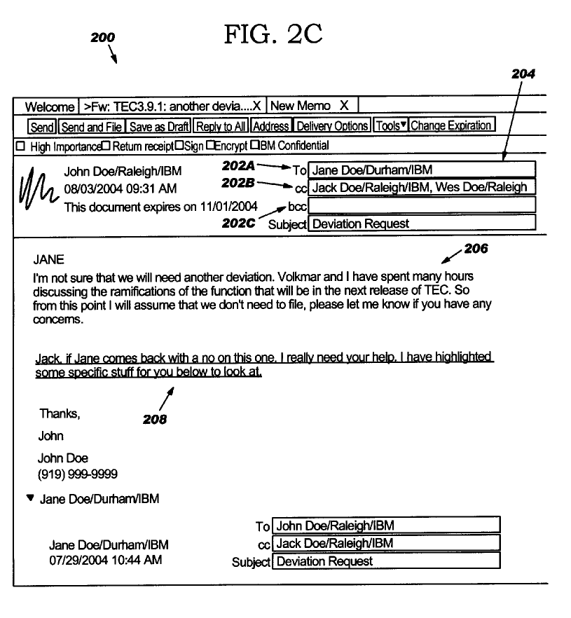

Referring also to FIG. 2A, FIG. 2A is an example of a screen shot or the like illustrating creation of a single e-mail 200 including different content for different recipients. If the user is composing a new message, he may enter at least two recipients into at least one of the address fields 202, in the message header 204, at least one recipient to receive the public content and at least one recipient to receive any private contents. The address fields may include a “To” field 202a, a carbon copy (“CC”) field 202b, and a blind carbon copy field (“BCC”) field 202c. If the user is replying to or forwarding a previously received message, he may select which of the previous recipients may receive the public contents and private contents. The user may also add any new recipients.

Referring again to FIG. 1A, in block 108 any private content may be entered, attached, or associated with the message. Only a designated or assigned private content recipient may view the private content. Private content may include text, media files, hyperlinks, formatted documents, spreadsheets, executable programs, or the like.

In block 109, any private content may be distinguished from the public content by formatting, highlighting or other appropriate distinguishing means. Distinguishing may allow each recipient to quickly find his private content. Distinguishing may also facilitate the sender in editing each private content to the different recipients. The private content may be distinguished manually by the user or the method 100 or system may be preset to automatically distinguish the private content form the public content. The method 100 or system may also be preset to distinguish each different private content differently if multiple different private contents are composed in a message or e-mail.

Manual distinguishing may include selecting a particular feature available in the message composition software. These features may include highlighting, various fonts (colors, type, and points), bolding, italics, or the like. FIG. 2A illustrates an example of distinguishing the private content in accordance with one embodiment of the present invention. In the example of FIG. 2A, the private content 208 has been underlined and enclosed in a box 209 that may be illustrative of highlighting or the like to select the private content. As previously discussed, this may be done manually by the user or automatically by the method 100 or system.

A user may enable the method 100 or system to automatically distinguish each new private content. The user may pre-set a distinct distinguishing or formatting style for each new private content up to a predetermined number of private contents. This style may be automatically applied in response to a recipient being associated with each new private content. For example, for a first private message, the content may be italicized or highlighted in yellow; for a second private content, the content may be bolded or highlighted in blue; and so forth for each additional private content.

In block 110, at least one private content recipient may be entered or selected. As discussed, a recipient may include an individual, a group, or an entity. If the user is composing a new message, he may enter at least two recipients in at least one of the address fields. If the user is replying to or forwarding a previously received message, he may select which previous message recipient may receive the private contents. The user may also add a new recipient.

FIGS. 2A and 2B are examples of screen shot images or the like, illustrating composition of a single e-mail including different contents intended for different recipients in accordance with an embodiment of the present invention. FIG. 2A illustrates a user replying to a previously received message. In FIG. 2A, the public content 206 and the private content 208 are also illustrated. The private content 208 may be distinguished or highlighted as illustrated in FIG. 2A. Private content 208 may be distinguished or highlighted by using a computer pointing device or the like similar to highlighting text in a word processing application.

In FIG. 2B, a drop-down menu 210 may be displayed to enter or select recipients of the private content 208. The drop-down menu 210 may be presented or displayed by a “right click” event using the computer pointing device or the like.

Referring back to FIG. 1A, in block 112, additional private content for any other recipients may be entered or attached. As previously discussed, private content may include: text, media files, hyperlinks, formatted documents, spreadsheets, executable programs, or the like. In block 114, any additional private content intended for a different recipient or recipients may be distinguished from other private content and public content. The formats may be preset or preselected for multiple contents to different recipients in a single e-mail or selected manually by the user.

In block 116, a recipient or recipients, may be entered, selected, assigned, or the like for each different private content, similar to that described with respect to block 110 and FIG. 2B. Accordingly, the present invention may allow for the additional private content to be designated for different private contents recipients. As previously discussed, each private content may be manually distinguished by the user or automatically by the method 100 or system to designate each private content for a specific associated recipient.

In block 118, the different private contents may be secured to permit only the assigned recipient or recipients to view the contents. Securing may involve automatically converting each different private content to a format that may be respectively read or viewed only by the assigned recipient or recipients. The securing may include converting and attaching the private content as a Multipurpose Internet Mail Extension (MIME) or the like. The securing may also involve using an encrypting technology.

If a private content recipient is using a web browser that can decipher encrypted private content, the private content may be encrypted. The recipient may insert an encryption key. An encryption key may be sent to the recipient via a separate communication to allow the reader to decrypt and view the private content. Alternatively, means for decrypting the private content may be prearranged by the parties.

If a private content recipient is using a web browser that may not decipher private contents, the private content may be included in a MIME attachment, or the like, in a multi part e-mail message. If a MIME attachment, or the like, is required, the private content and public content are viewable as separate messages. The MIME attachment is locked so that it can only be assessed and viewed by the intended recipient.

Referring back to FIG. 2C, any recipient or recipients that are not intended to receive private content 208 would receive a message without this content and only receive the public content 206. In the example in FIG. 2C, the private content 208 is distinguished from the public content 206 by underlining.

In block 120, the message may be transmitted to the all intended recipients. Typically, the send button 210 (FIG. 2A-2C) or command may be used to initiate the process of transmitting the message to the intended recipients. However, the present inventive method is intended to encompass all e-mail composition software to include those which initiate transmitting a message without the use of a send command.

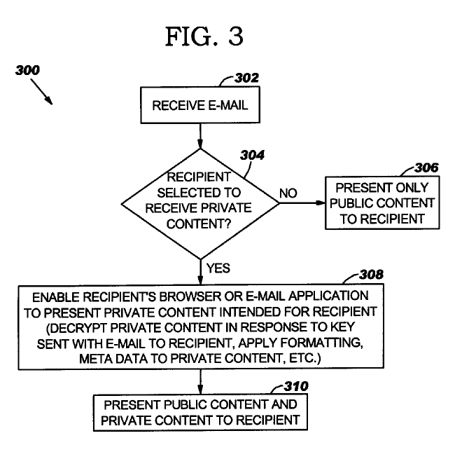

FIG. 3 is a flow chart of a method 300 of receiving a single e-mail including different content intended for different recipients in accordance with an embodiment of the present invention.

In block 302, a recipient may receive an e-mail including different content intended for different recipients in accordance with an embodiment of the present invention. The message may be accessed on a communication device, such as a computer system, a personal digital assistant, a cellular phone, or similar devices capable of receiving an electronic message.

In block 304, the method 300 or system may determine whether the recipient may receive any private content. As discussed, the method 100 or system may provide for designating a recipient for the public content. The method 100 or system may also provide designating a recipient for the public content and at least one private content. If the method 300 or system determines that the recipient was not designated to receive a private content in block 304, the method 300 or system may proceed to block 306. In block 306, the method 300 or system may only present public content to the recipient.

If the recipient was selected to receive private content, the method 300 may advance to block 308. In block 308, the method 300 or system may enable the recipient's browser or e-mail application to present the private content. In block 308, the method 300 or system may decrypt the private content in response to an encryption key previously received by the recipient. After the recipient enters the encryption key, the private content may be formatted and presented to the recipient using metadata or similar formatting data. Alternatively, if the private content was sent as a MIME attachment, the private content may be formatted using the metadata or the like and presented to the recipient.

In block 310, the method 300 or system may present the public and private content to the recipient. The recipient may view the message on any of previously described communication devices, or the like. If the recipient's browser or e-mail application may decrypt the private content, the private content and public content may be viewed as in the same window. Alternatively, if the recipient's browser or e-mail application may not decipher the encrypted private content, the public content may be viewed in a window and the private content may be viewed in a separate windows.

The method 300 or system may provide additional security for the private content. A recipient may desire to forward or reply to a previously sent or received message that contained any private content. Accordingly, the method 300 or system may prevent any private content received in a previous message from being included in forwarding or replying to that message. This feature, in accordance with an embodiment, of the present invention may ensure that any private content is not transmitted by a recipient or recipients whom were not originally designated to receive the private content.

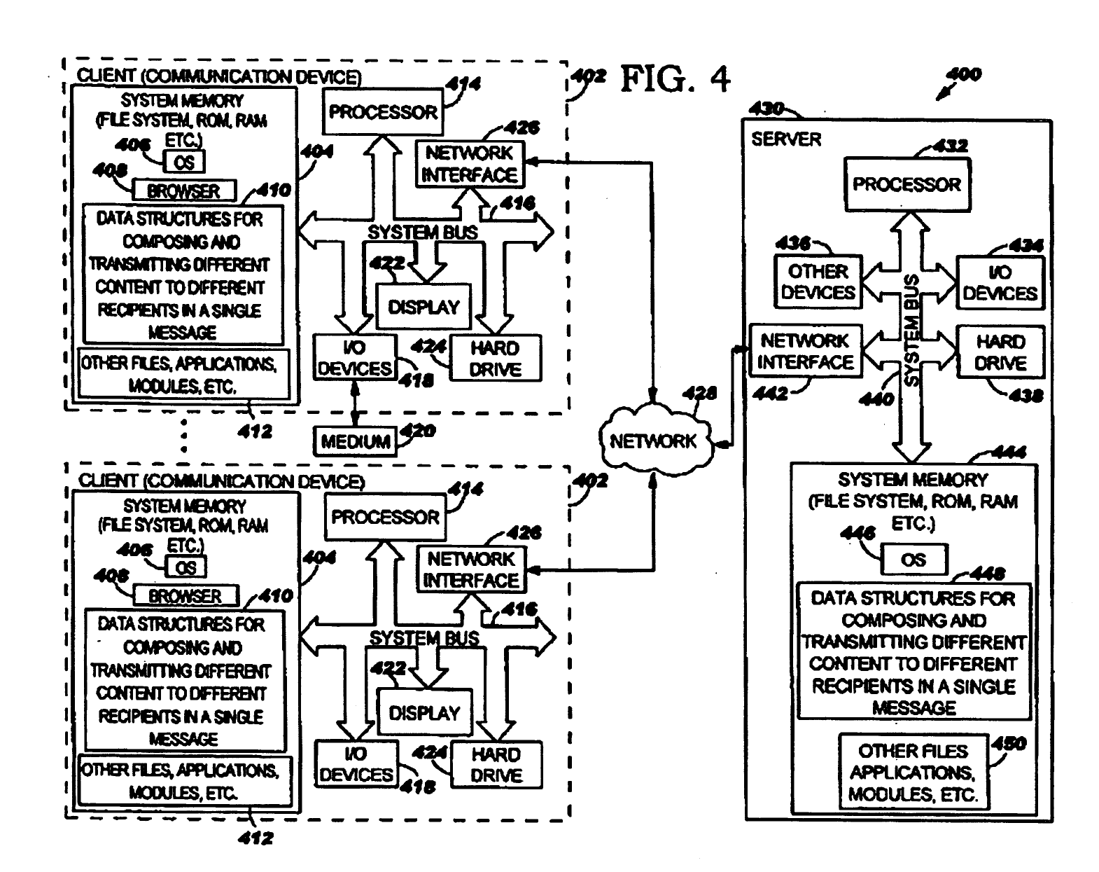

FIG. 4 is a block diagram of an exemplary system 400 to compose and transmit different content to different recipients in a single message in accordance with an embodiment of the present invention. The elements of the method 100 and 300 may be embodied in and performed by the system 400. The system 400 may include one or more user or client communication devices 402 or similar systems or devices. Communication devices may be a computer system, a personal digital assistant, a cellular phone, or similar devices capable of sending and receiving an electronic message.

The communication device 402 may include a system memory or local file system 404. The system memory 404 may include a read only memory (ROM) and a random access memory (RAM). The ROM may include a basic input/output system (BIOS). The BIOS may contain basic routines that help to transfer information between elements or components of the communication device 402. The system memory 404 may contain an operating system 406 to control overall operation of the communication device 402. The system memory 404 may also include a browser 408 or web browser. The system memory 404 may also include data structures 410 or computer-executable code to compose and transmit different content to different recipients in a single message that may be similar or include elements of the methods 100 and 300 of FIGS. 1 and 3. The system memory 404 may further include other application programs 412, other program modules, data, files and the like.

The communication device 402 may also include a processor or processing unit 414 to control operations of the other components of the communication device 402. The operating system 406, browser 408, data structures 410 and other program modules 412 may be operable on the processor 414. The processor 414 may be coupled to the memory system 404 and other components of the communication device 402 by a system bus 416.

The communication device 402 may also include multiple input devices, output devices or combination input/output devices 418. Each input/output device 418 may be coupled to the system bus 416 by an input/output interface (not shown in FIG. 4). The input and output devices or combination I/O devices 418 permit a user to operate and interface with the communication device 402 and to control operation of the browser 408 and data structures 410 to access, operate and control the enhanced e-mail software. The I/O devices 418 may include a keyboard and computer pointing device or the like to perform the operations discussed herein.

The I/O devices 418 may also include disk drives, optical, mechanical, magnetic, or infrared input/output devices, modems or the like. The I/O devices 418 may be used to access a medium 420. The medium 420 may contain, store, communicate or transport computer-readable or computer-executable instructions or other information for use by or in connection with a system, such as the communication devices 402.

The communication device 402 may also include or be connected other devices, such as a display or monitor 422. The monitor 422 may be used to permit the user to interface with the communication device 402. The monitor 422 may present the screen shots illustrated in FIG. 2 that may be generated by the data structures 410 for enhanced e-mail software.

The communication device 402 may also include a hard disk drive 424. The hard drive 424 may be coupled to the system bus 416 by a hard drive interface (not shown in FIG. 4). The hard drive 424 may also form part of the local file system or system memory 404. Programs, software and data may be transferred and exchanged between the system memory 404 and the hard drive 424 for operation of the communication device 402.

The communication devices 402 may communicate with a remote server 430 and may access other servers or other communication devices (not shown) similar to communication device 402 via a network 428. The system bus 416 may be coupled to the network 428 by a network interface 426. The network interface 426 may be a modem, Ethernet card, router, gateway or the like for coupling to the network 428. The coupling may be a wired connection or wireless. The network 428 may be the Internet, private network, an intranet or the like.

The server 430 may also include a system memory 444 that include a file system, ROM, RAM and the like. The system memory 444 may include an operating system 446 similar to operating system 406 in communication devices 402. The system memory 444 may also include data structures 448 to compose and transmit different content to different recipients in a single message that may be similar or include elements of the methods 100 and 300 of FIGS. 1 and 3. The data structures 448 may include operations similar to those described with respect to method 100 for composing an enhanced e-mail in FIG. 1. Clients, such as communication devices 402 or the like, may access the data structures 448 including those described with respect to method 300 in FIG. 3 for receiving an e-mail including different contents to different recipients in a single message, in accordance with an embodiment of the present invention.

The server system memory 444 may also include other files 450, applications, modules and the like. The system memory 444 may further include a traffic log 252 and a termination log 254.

The server 430 may also include a processor 432 or a processing unit to control operation of other devices in the server 430. The server 432 may also include I/O device 434. The I/O devices 434 may be similar to I/O devices 418 of communication devices 402. The server 430 may further include other devices 436, such as a monitor or the like to provide an interface along with the I/O devices 434 to the server 430. The server 430 may also include a hard disk drive 438. A system bus 440 may connect the different components of the server 430. A network interface 442 may couple the server 430 to the network 428 via the system bus 440.

Elements of the present invention, such as methods 100 and 300 of FIGS. 1 and 3 and system 400 of FIG. 4, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in the medium for use by or in connection with a system, such as system 400 of FIG. 4. Examples of such a medium may be illustrated in FIG. 4 as network 428 or medium 420 and I/O devices 418 and 434. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

While the blocks in FIGS. 1A, 1B and 3 are shown in a particular order or sequence, other orders or sequence may be possible and this invention is not intended to be limited by the specific examples describe herein.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method to compose and transmit different contents to different recipients in a single message, comprising:
entering a plurality of different contents in a single message; assigning at least one recipient of a plurality of recipients to each of the different contents; and
securing the different contents to permit only the assigned recipient to view the contents.

2. The method of claim 1, further comprising:
entering a public content intended for all recipients of the plurality of recipients of the single message;
entering private contents; and
assigning at least one recipient of the plurality of recipients to receive the private contents, wherein only the at least one assigned recipient can view the private contents.

3. The method of claim 2, further comprising distinguishing the private contents from the public content.

4. The method of claim 3, wherein distinguishing the private contents renders the private contents in a different format compared to the public contents.

5. The method of claim 4, further comprising:
entering any additional private contents; and
assigning at least one other recipient of the plurality of recipients to each additional private contents.

6. The method of claim 5, further comprising encrypting each of the private contents, wherein only the at least one assigned recipient of each private contents is enabled to decrypt the private contents.

7. The method of claim 5, further comprising converting each of the private contents and attaching to the single message as a MIME attachment.

8. The method of claim 5, further comprising preselecting the different formats for the public contents and each of the private contents.

9. The method of claim 5, further comprising selecting the different formats for each of the private contents after entering the private contents.

10. The method of claim 1, wherein entering the plurality of different contents comprises entering or attaching at least one of text, a media file, a hyperlink, a document, a spreadsheet, executable programs, or the like for each different contents.

11. A system to compose and transmit different contents to different recipients in a single message, comprising:
a data structure operable on a processor to facilitate entering a plurality of different contents in a single message;
a data structure operable on the processor to facilitate assigning at least one recipient of a plurality of recipients to each different contents; and
a data structure operable on the processor to facilitate securing the different contents to permit only the assigned recipient to view the contents.

12. The system of claim 11, further comprising:
a data structure to facilitate entering a public content intended for all recipients of the plurality of recipients of the single message;
a data structure to facilitate entering private contents, wherein the private contents are distinguishable relative to the public content; and
a data structure to facilitate assigning at least one recipient of the plurality of recipients to receive the private contents, wherein only the at least one assigned recipient can view the private contents.

13. The system of claim 12, further comprising a data structure operable to encrypt each of any additional private contents, wherein only an assigned recipient of each private contents is enabled to decrypt the private contents.

14. The system of claim 12, further comprising a data structure operable to attach each of the private contents to the single message as a MIME attachment.

15. The system of claim 12, further comprising a data structure operable to distinguish each of the private contents and the public content.

16. The system of claim 15, further comprising a data structure operable to select a different format for the public content and each of the private contents to distinguish each of the different contents.

17. A computer program product to compose and transmit different contents to different recipients in a single message, the computer program product comprising:
a computer readable medium having computer readable program code embodied therein, the computer readable medium including:
computer readable program code configured to facilitate entering a plurality of different contents in a single message;
computer readable program code configured to facilitate assigning at least one recipient of a plurality of recipients to each different contents; and
computer readable program code configured to secure each private contents to only be viewable by the at least one assigned recipient.

18. The computer program product of claim 17, further comprising:
computer readable program code configured to facilitate entering a public content intended for all recipients of the plurality of recipients of the single message;
computer readable program code configured to facilitate entering private contents, wherein the private contents are distinguishable relative to the public content; and
computer readable program code configured to facilitate assigning at least one recipient of the plurality of recipients to receive the private contents, wherein only the at least one assigned recipient can view the private contents.

19. The computer program product of claim 18, further comprising computer readable program code configured to encrypt any additional private contents, wherein only an assigned recipient of each private contents is enabled to decrypt the private contents.

20. The computer program product of claim 18, further comprising computer readable program code configured to facilitate attaching each of the private contents to the single message as a MIME attachment.

21. The computer program product of claim 19, further comprising computer readable program code configured to distinguish the different formats for the public content and each of the private contents.

22. The computer program product of claim 19, further comprising computer readable program code configured to select a different format for the public content and each of the private contents to distinguish each of the different contents.
